(19) United States
(12) Patent Application Publication
(10) Pub. No.: US 2008/0000158 A1
(43) Pub. Date: Jan. 3, 2008

(54) Sliding door including a support apparatus

(75) Inventors: Vincent Orlando Ranelli, Shelby Twp., MI (US); Gregory Raymond Jacobs, Belleville, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: J.R.W. Ventures

(21) Appl. No.: 11/451,008

(22) Filed: Jun. 12, 2006

(51) Int. Cl. E05D 15/10

(52) U.S. Cl. 49/209; 49/425

(57) ABSTRACT

A sliding door assembly for enclosing a space, such as a shower or a bath, includes an overhead track and a sliding door moveably interacting with the overhead track. The sliding door includes a panel and a support apparatus for supporting the panel. The support apparatus includes a rail extending generally vertically and connected to the panel, a bracket extending upwardly from and partially adjacent to the rail for moveably interacting with the overhead track, and a boss extending from the rail and engaging the bracket. The bracket defines a notch and the boss extends from the rail into the notch and vertically engages the bracket in the notch for vertically supporting the rail on the bracket. The boss and the bracket establish a fastener-free support to support the weight of the panel and the rail.

### BACKGROUND OF THE INVENTION

1. Field of the Invention

The invention generally relates to a sliding door assembly for enclosing a space. Specifically, the sliding door assembly includes an overhead track and at least one sliding door moveably interacting with the overhead track. More specifically, the sliding door includes a rail extending generally vertically and a bracket extending upwardly from and partially adjacent to the rail for moveably interacting with the overhead track.

2. Description of the Related Art

Various sliding door assemblies for enclosing a space are known in the art. These sliding door assemblies typically include an overhead track and at least one sliding door moveably interacting with the overhead track. The sliding door is moveable along the overhead track between an open position thereby allowing ingress and egress past the sliding door, and a closed position thereby preventing ingress and egress past the sliding door.

Traditionally, the sliding door is a framed sliding door, i.e. the sliding door includes a panel and a frame surrounding the panel. The panel is generally rectangular and has four edges and the frame surrounds the four edges. The frame includes a pair of vertical rails extending vertically along vertical edges of the panel, a header extending along a top horizontal edge of the panel, and a footer extending along a bottom horizontal edge of the panel, i.e. the vertical rails, and the header, and the footer frame the panel. The header moveably interacts with the overhead track.

Frameless sliding doors are also known in the art. Unlike the framed sliding door, the frameless sliding door does not require the header and the footer extending along the top and bottom horizontal edges, respectively, of the panel. It is advantageous and aesthetically pleasing to manufacture the sliding door that is frameless. The frameless sliding door is advantageous over the framed sliding door in that fewer parts are required thereby simplifying the sliding door and reducing manufacturing and assembly costs. Frameless sliding doors typically include a panel, at least one rail extending generally vertically and connected to the panel, and a bracket extending upwardly from and partially adjacent to the rail for moveable interaction with the overhead track. Difficulties arise in the frameless sliding door with respect to attaching the bracket to the rail.

An example of the frameless sliding door is disclosed in the U.S. Pat. No. 3,852,916 to Laby (the '916 patent). As disclosed in the '916 patent, the rail presents a side and the side defines a hole. The bracket defines a plurality of notches and the bracket may be moved relative to the rail to align the notches of the bracket with the hole defined in the side of the rail. The sliding door includes a spring clip presenting a flange. The spring clip is attached to the rail and the flange extends through the hole in the side of the rail and engages one of the notches defined in the bracket to maintain the bracket in position relative to the rail. The flange of the spring clip is moveable relative to the hole in the side of the rail such that flange is disengageable with the notch to allow movement of the bracket relative to the rail. The weight of the rail and the panel is supported by the engagement of the flange with one of the notches. The flange of the spring clip must be strong enough to support the weight of the rail and the panel. In addition, the flange of the spring clip may be inadvertently moved relative to the hole such that the flange disengages with the notch thereby allowing movement of the bracket relative to the rail. Additionally, the clip is visible along the side of the rail and is, therefore, aesthetically unpleasing.

It would be desirable to manufacture a frameless sliding door with a fastener-free support to support the weight of the panel and the rail. Additionally, it would desirable to manufacture a sliding door wherein the weight of the sliding door is firmly supported by a strong and durable structure. In addition, it would desirable to manufacture a bracket that is securely engaged with the rail to prevent inadvertent disengagement of the bracket and the rail. It would also desirable to manufacture a frameless sliding door that has an aesthetically pleasing appearance.

### SUMMARY OF THE INVENTION AND ADVANTAGES

The present invention is a sliding door assembly for enclosing a space. The sliding door assembly includes an overhead track and at least one sliding door moveably interacting with the overhead track. The sliding door includes a panel and at least one support apparatus for supporting the panel. The support apparatus includes a rail extending generally vertically and connected to the panel, a bracket extending upwardly from and partially adjacent to the rail for moveably interacting with the overhead track, and a boss extending from the rail and engaging the bracket. Specifically, the bracket defines a notch and the boss extends from the rail into the notch and vertically engages the bracket in the notch for vertically supporting the rail on the bracket.

The boss and the notch provide a fastener-free support to support the weight of the panel and the rail. Additionally, the boss and the notch provide a strong and durable engagement to firmly support the weight of the sliding door. In addition, the boss is firmly engaged in the notch such that the boss and the notch are not subject to inadvertent disengagement. Additionally, the engagement between the boss and the notch is not visible when the sliding door is assembled to the sliding door assembly thereby giving the sliding door a cleaner and more aesthetically pleasing appearance.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a sliding door assembly including an overhead track, a first sliding door assembly moveably engaging the overhead track, and a second sliding door assembly moveably engaging the overhead track;

FIG. 2 is a partial side view of the sliding door assembly of FIG. 1 wherein the overhead track includes a first ledge and a second ledge and wherein the first sliding door moveably interacts with the first ledge and the second sliding door moveably interacts with the second ledge;

FIG. 3 is a partially exploded view of the sliding door shown in FIG. 1 including a panel and a support apparatus;

FIG. 4 is a partial cross-sectional view of the support apparatus including a rail, a bracket defining a notch, and a boss extending from the rail and engaging the bracket in the notch wherein the notch is trapezoidal-shaped and the boss has a frustoconical shape;

FIG. 5 is a perspective view of the bracket of FIG. 4;

FIG. 6 is a partial cross-sectional view of the rail of FIG. 4;

FIG. 7 is a partial cross-sectional view of the support apparatus including the bracket wherein the notch in the bracket is arcuate-shaped; and

FIG. 8 is a partial cross-sectional view of the support apparatus including the bracket and the boss wherein the notch in the bracket is rectangular-shaped and the boss has a rectangular shape.

### DETAILED DESCRIPTION OF THE INVENTION

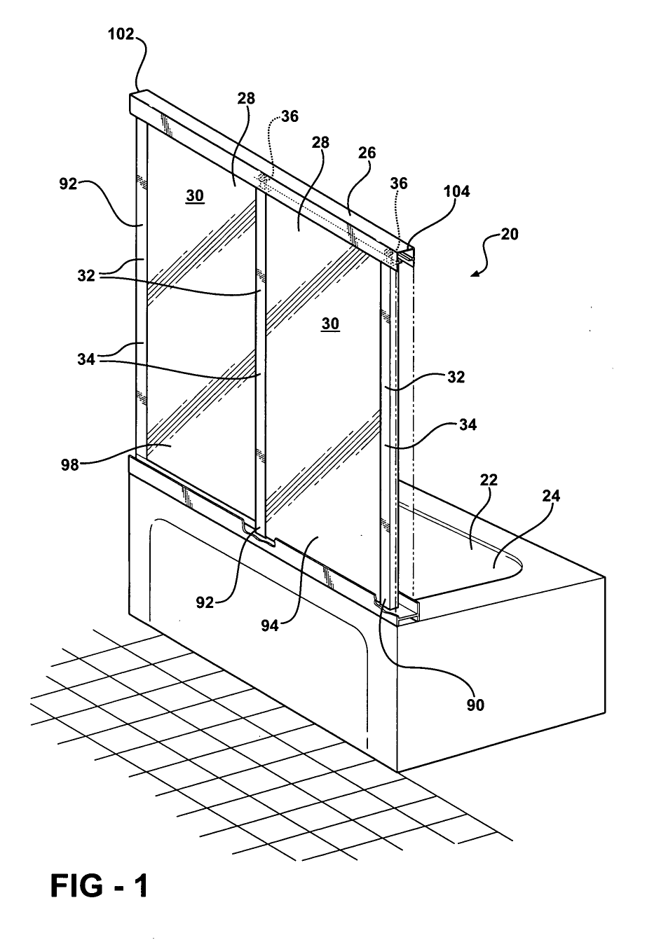

Referring to the Figures, wherein like numerals indicate corresponding parts throughout the several views, a sliding door assembly is shown generally at 20. The sliding door assembly 20 is for enclosing a space 22. For example, as shown in FIG. 1, the space 22 is a bathtub shower 24. It should be appreciated that the space 22 may be any type of space 22 including, but not limited to, a shower, a bath, a closet, or a cabinet.

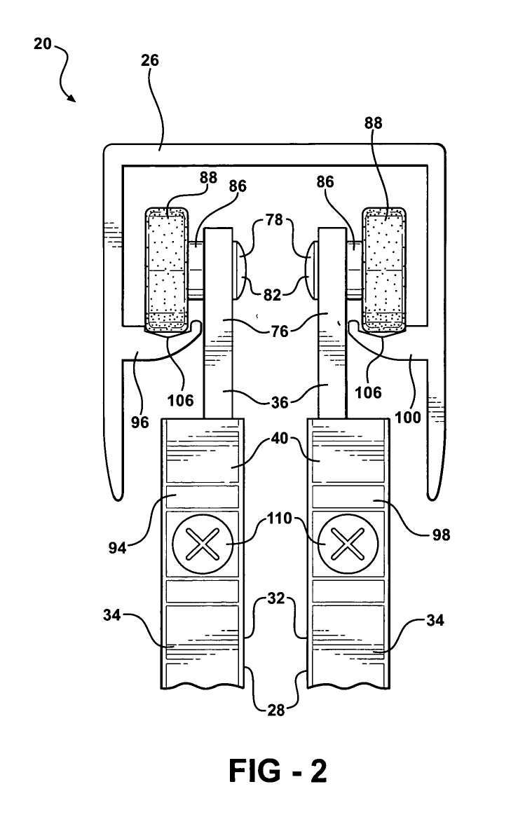

As shown in FIGS. 1 and 2, the sliding door assembly 20 includes an overhead track 26 and at least one sliding door 28 moveably interacting with the overhead track 26. In other words, the sliding door 28 is moveable along the overhead track 26. Specifically, the sliding door 28 is preferably moveable along the overhead track 26 between an open position thereby allowing ingress and egress past the sliding door assembly 20, and a closed position thereby preventing ingress and egress through the sliding door assembly 20. For example, with the bathtub shower 24, the sliding door 28 is moveable to the open position such that the user may enter and exit the bathtub shower 24, and moveable to the closed position so as to limit the escape of water and steam from the bathtub shower 24.

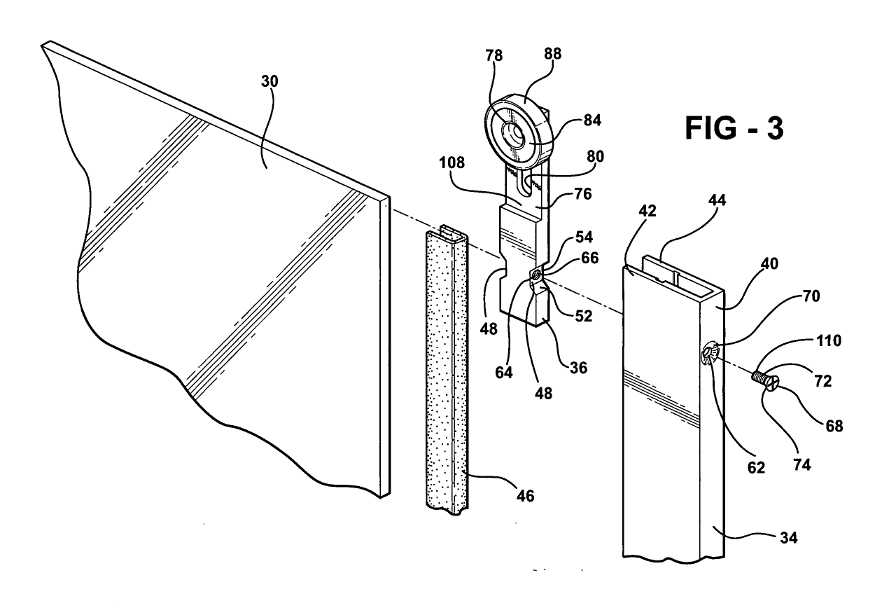

As shown in FIGS. 1 and 3, preferably, the sliding door 28 includes a panel 30 and at least one support apparatus 32 for supporting the panel 30. It should be appreciated that the panel 30 is preferably formed of rigid material. For example, the panel 30 is formed of tempered glass or plastic and may be clear, translucent, or opaque. With the bathtub shower 24, the panel 30 deflects water and steam and, if desired, is frosted or dimpled to decrease visibility through the panel 30.

As shown in FIGS. 3, 4, 7, and 8, the support apparatus 32 includes a rail 34, a bracket 36 extending upwardly from and partially adjacent to the rail 34, and a boss 38 extending from the rail 34 and engaging the bracket 36. The bracket 36 moveably interacts with the overhead track 26.

The rail 34 extends generally vertically and is connected to the panel 30. Specifically, as shown in FIGS. 3, 4, and 6, the rail 34 is further defined by a side 40, a first member 42 extending from the side 40, and a second member 44 extending from the side 40. More specifically, the side 40 is partially adjacent the boss 38 with the boss 38 extending in a first direction from the side 40. The first member 42 extends from the side 40 generally in the first direction. The second member 44 extends from the side 40 generally in parallel with the first member 42 in the first direction and is spaced from the first member 42. In other words, the side 40, the first member 42, and the second member 44 define a U-shaped cross-section with the boss 38 extending into the U-shaped cross-section. It should be appreciated that the rail 34 is formed of any rigid material, and for example, the rail 34 is formed of non-corrosive metal such as aluminum.

As shown in FIG. 3, the rail 34 receives and is secured to the panel 30 between the first member 42 and the second member 44 with the bracket 36 disposed between the panel 30 and the side 40 of the rail 34. Preferably, the bracket 36 is pinched between the panel 30 and the side 40 of the rail 34 such that the bracket 36 is not moveable relative to the panel 30 or the rail 34.

Preferably, adhesive (not shown) is disposed in the rail 34 between the side 40 and the first member 42 and the second member 44 and is adhered to the rail 34 and the panel 30 for securing the panel 30 in the U-shaped cross-section. Preferably, a retainer strip 46 is disposed on the panel 30 and in the U-shaped cross-section. For example, the retainer strip 46 may be formed of rubber or vinyl. The retainer strip 46 and the adhesive secure the panel 30 in the U-shaped cross-section and form a water-tight seal between the panel 30 and the rail 34.

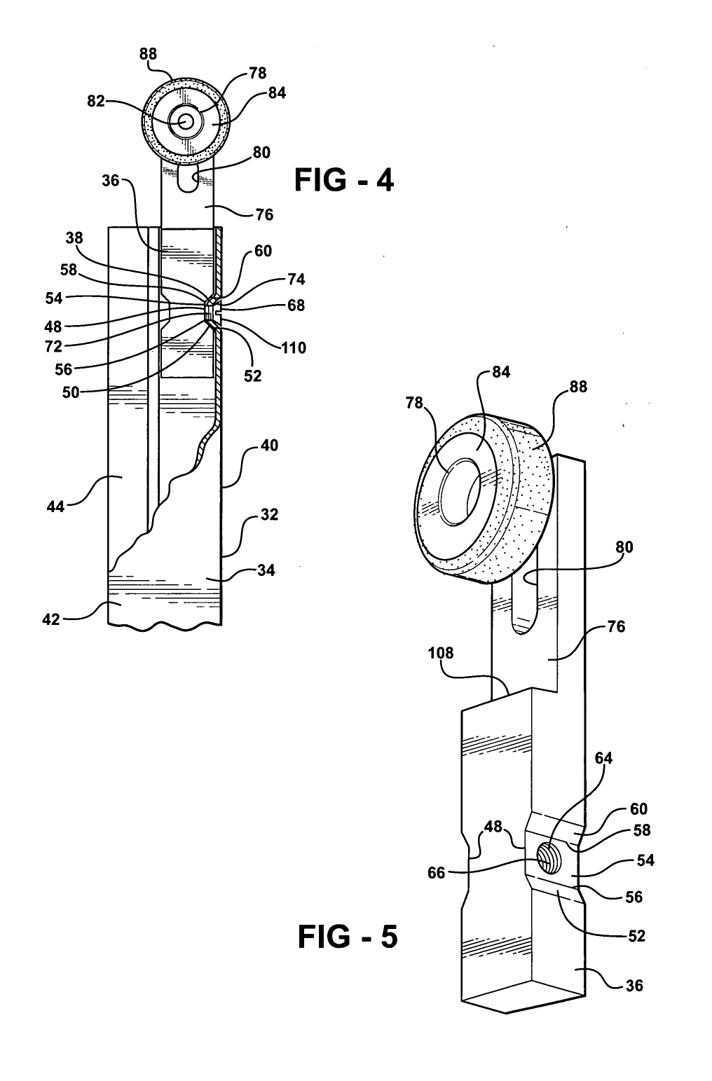

As shown in FIGS. 4, 5, 7, and 8, the bracket 36 defines a notch 48 and the boss 38 extends from the rail 34 into the notch 48 and engages the bracket 36 in the notch 48 for vertically supporting the rail 34 on the bracket 36. In other words, the bracket 36 and the rail 34 are interconnected by the engagement of the boss 38 and the notch 48. The boss 38 supports the weight of the rail 34 and the panel 30, i.e. establishing a fastener-free support for supporting the weight of the rail 34 and the panel 30. With the bracket 36 preferably pinched between the panel 30 and the side 40 of the rail 34, the boss 38 remains engaged with the bracket 36 in the notch 48. Because the rail 34 is vertically supported on the bracket 36 and because the bracket 36 moveably interacts with the overhead track 26, the rail 34 hangs from the bracket 36 and moves with the bracket 36 as the bracket 36 is moved along the overhead track 26.

Because the boss 38 vertically supports the rail 34 on the bracket 36, the sliding door 28 is, as known to one skilled in the art, a frameless sliding door 28. In other words, the frameless sliding door 28 does not require a header and a footer extending along horizontal edges of the panel 30 whereas a framed sliding door does include a header and a footer extending along horizontal edges of the panel 30. Specifically, with the framed sliding door, the header, the footer, and a pair of vertical rails surround, or frame, the panel 30. The header of the framed sliding door moveably interacts with the overhead track 26. The frameless sliding door 28 is advantageous in that the number of parts is reduced thereby simplifying the sliding door 28 and reducing manufacturing and assembly costs in comparison to the framed sliding door. In addition, the frameless sliding door 28 has a distinctive and aesthetically pleasing appearance in comparison to the framed sliding door.

Specifically, as shown in FIGS. 4, 7, and 8, the boss 38 presents a contact surface 50 and the bracket 36 presents an adjoining surface 52 partially defining the notch 48 and in contact with the contact surface 50 of the boss 38. The contact surface 50 of the boss 38 and the adjoining surface 52 of the bracket 36 establish the fastener-free support to support the weight of the panel 30 and the rail 34. In other words, because the panel 30 and the rail 34 are connected to each other and because the rail 34 hangs from the bracket 36, the weight of the panel 30 and the rail 34 are supported on the contact surface 50 of the boss 38.

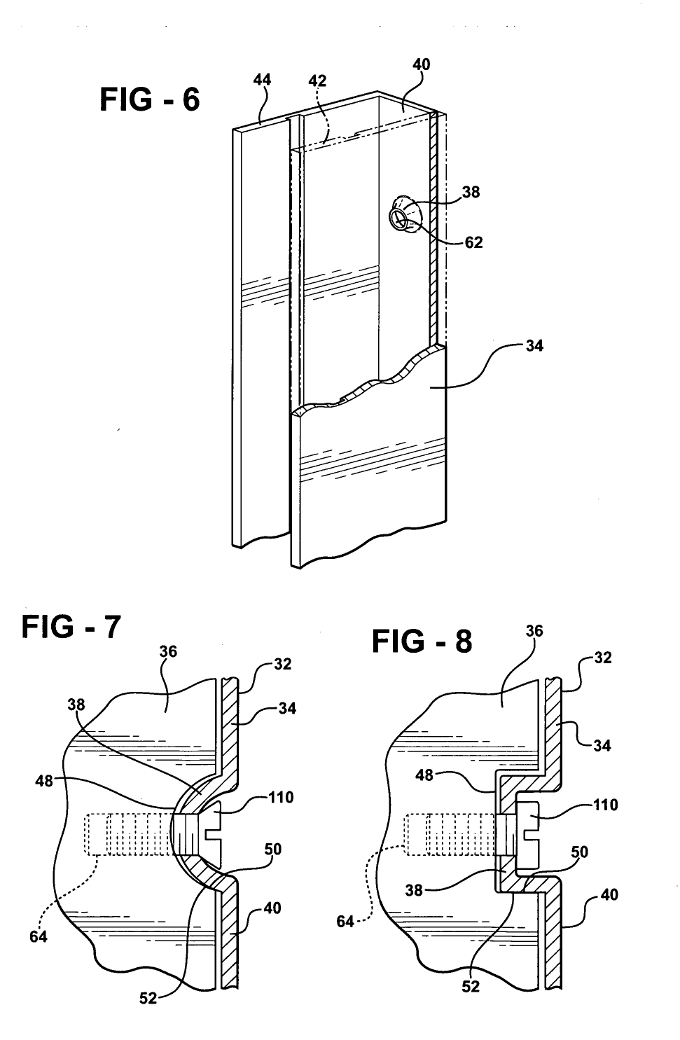

More specifically, as shown in FIG. 6, the boss 38 is further defined as having a frustoconical shape. As shown in FIG. 5, the notch 48 is trapezoidal-shaped for receiving the frustoconical shape of the boss 38 in the notch 48. The notch 48 is defined by a base surface 54 extending between a first end 56 and a second end 58. The adjoining surface 52 extends downwardly from the first end 56 at an obtuse angle relative to the base surface 54 and an opposite surface 60 extends upwardly from the second end 58 at an obtuse angle relative to the base surface 54. In other words, the frustoconical shape of the boss 38 presents the contact surface 50 and because the frustoconical shape of the boss 38 is received by the trapezoidal-shaped notch 48, gravity maintains the adjoining surface 52 of the notch 48 in contact with the contact surface 50 of the boss 38.

Alternatively, as shown in FIG. 7, the notch 48 is arcuate-shaped for receiving the frustoconical shape of the boss 38 in the notch 48. In such an embodiment, the arcuate-shaped notch 48 presents the adjoining surface 52. Because the frustoconical shape of the boss 38 is received by the arcuate-shaped notch 48, gravity maintains the adjoining surface 52 of the notch 48 in contact with the contact surface 50 of the boss 38.

Alternatively, as shown in FIG. 8, the boss 38 is further defined as having a rectangular shape and the notch 48 is rectangular-shaped for receiving the rectangular shape of the boss 38 in the notch 48. In such an embodiment, the rectangular-shaped boss 38 presents the contact surface 50 and the rectangular shape of the notch 48 presents the adjoining surface 52. Because the rectangular shape of the boss 38 is received by the rectangular-shaped notch 48, gravity maintains the adjoining surface 52 of the notch 48 in contact with the contact surface 50 of the boss 38.

It should be appreciated that the boss 38 and the notch 48 may be any shape such that the boss 38 presents the contact surface 50 and the notch 48 presents the adjoining surface 52 wherein the contact surface 50 contacts the adjoining surface 52 when the notch 48 receives the boss 38 for vertically supporting the rail 34 with the bracket 36.

Preferably, the boss 38 defines a hole 62 and the bracket 36 defines an orifice 64 extending into the bracket 36 at the notch 48 with the orifice 64 in alignment with the hole 62. Specifically, as shown in FIG. 6, when the boss 38 has the frustoconical shape, the hole 62 is defined through the frustoconical shape of the boss 38 concentrically with the frustoconical shape of the boss 38. The boss 38 is preferably formed by punching the side 40 of the rail 34 with a metal punch such that the frustoconical shape and the hole 62 are formed by the metal punch. As shown in FIG. 5, when the notch is trapezoidal-shaped, the orifice 64 is preferably defined through the base surface 54 of the bracket 36.

Preferably, a fastener 110 extends through the hole 62 and into the orifice 64 for maintaining the engagement of the boss 38 and the bracket 36 at the notch 48. In other words, in addition to the engagement of the boss 38 and the bracket 36, the fastener 110 is preferably disposed in the hole 62 and the orifice 64 to vertically support the rail 34 on the bracket 36. In addition to the bracket 36 preferably being pinched between the rail 34 and the panel 30, the fastener 110 extends through the hole 62 and into the orifice 64 and engages the hole 62 and the orifice 64 such that the bracket 36 is not moveable relative to the rail 34. It should be appreciated that the fastener 110 is any type of fastener, including but not limited to a nut/bolt combination, a pin, or a stake such that the fastener 110 extends through the hole 62 and into the orifice 64. For example, as shown in FIGS. 2-4, and 7-8, the bracket 36 defines threads 66 in the orifice 64 and the fastener 110 is threaded and threadedly engages the threads 66 in the orifice 64 for maintaining the engagement of the boss 38 and the bracket 36 at the notch 48. In other words, the fastener 110 extends through the hole 62 and engages the threads 66 such that the bracket 36 is not moveable relative to the rail 34.

As shown FIGS. 3-4, when the boss has the frustoconical shape, the fastener 110 is preferably a flat head screw and the side 40 of the rail 34 defines a recess 70 for receiving the flat head screw. In other words, the flat head screw preferably includes a threaded shank 72, a flat head 68, and a tapered surface 74 tapering outwardly from the threaded shank 72 to the flat head 68. When the flat head screw is threadedly engaged with the bracket 36 through the hole 62 in the side 40 of the rail 34, the tapered surface 74 is disposed in the recess 70 and the flat head 68 is flush with the side 40 of the rail 34.

As shown in FIGS. 2-8, the bracket 36 preferably includes an extension 76 and a roller 78 rotatably mounted to the extension 76 for rotating along the overhead track 26 to moveably interact with the overhead track 26. Preferably, the extension 76 defines a vertically oblong slot 80 and the roller 78 includes a fastening device 82 to fasten the roller 78 to the extension 76 along the oblong slot 80 such that a position of the roller 78 relative to the extension 76 is adjustable along the oblong slot 80. Preferably, the roller 78 includes a bearing 84, a spacer 86 disposed between the bearing 84 and the extension 76 of the bracket 36, and a wheel 88 rotatable about the bearing 84. The bearing 84 defines a first threaded bore and the spacer 86 defines a second threaded bore in alignment with the first threaded bore. The fastening device 82 extends through the oblong slot 80 and threadedly engages the first threaded bore of the bearing 84 and the second threaded bore of the spacer 86. The fastening device 82 is loosened relative to the first and second threaded bores to allow the roller 78 to slide along the oblong slot 80. The fastening device 82 is tightened relative to the first and second bores to pinch the spacer 86 between the bearing 84 and the extension 76 of the bracket 36 to secure the roller 78 in position along the oblong slot 80. Because the first and second threaded bores are threaded, the spacer 86 acts as a jam nut. The fastening device 82 is preferably a screw.

It should be appreciated that the sliding door 28 includes one or more support apparatus 32. As shown in FIG. 1, preferably the support apparatus 32 is further defined as a first support apparatus 90 and a second support apparatus 92 and the panel 30 extends between the first support apparatus 90 and the second support apparatus 92.

In a first embodiment of the sliding door assembly 20, the sliding door assembly 20 includes a first sliding door 94 and the overhead track 26 presents a first ledge 96 extending along the track. The first sliding door 94 moveably interacts with the first ledge 96.

In a second embodiment, the sliding door assembly 20 includes a first sliding door 94 and a second sliding door 98. The first and second sliding doors 94, 98 moveably interact with the first ledge 96. In the second embodiment, the first and second sliding doors 94, 98 are moveable along the first ledge 96 toward each other such that the first and second sliding doors 94, 98 meet and abut one another.

In a third embodiment, as shown in FIG. 1, the sliding door assembly 20 includes the first sliding door 94 and the second sliding door 98. The overhead track 26 presents the first ledge 96 a second ledge 100 spaced from and extending in parallel with the first ledge 96. The first sliding door 94 moveably interacts with the first ledge 96 and the second sliding door 98 moveably interacts with the second ledge 100 such that the first sliding door 94 and the second sliding door 98 are in a bi-pass arrangement. In other words, as shown in FIG. 1, the overhead track 26 presents a distal end 102 and a proximal end 104 and first ledge 96 and the second ledge 100 extend between the distal end 102 and the proximal end 104. The first sliding door 94 is moveable along the first ledge 96 between the distal end 102 and the proximal end 104 of the overhead track 26 regardless of the position of the second sliding door 98. The second sliding door 98 is moveable along the second ledge 100 between the distal end 102 and the proximal end 104 of the overhead track 26 regardless of the position of the first sliding door 94.

In the first, the second, and the third embodiments, preferably, the roller 78 mounted to the extension 76 of the bracket 36 is rotatable along the ledge 96, 100. Specifically, as shown in FIG. 2, the ledge 96, 100 defines a channel 106 and the wheel 88 of the roller 78 fits in and rotates along the channel 106. Preferably, the bracket 36 defines a cutout 108 and the roller 78 is at least partially disposed in the cutout 108 such that the ledge 96, 100 is at least partially disposed in the cutout 108 when the wheel 88 is engaged in the channel 106. The ledge 96, 100 is preferably partially disposed in the cutout 108 of the bracket 36 so that the rail 34, extending downwardly from the bracket 36, extends at least partially below the overhead rail 34.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

What is claimed is:

1. A sliding door for enclosing a space, said sliding door comprising:
a panel;
at least one support apparatus for supporting said panel, said support apparatus comprising;
a rail extending generally vertically and connected to said panel;
a bracket defining a notch and extending upwardly from and partially adjacent to said rail for moveable interaction with an overhead track; and
a boss extending from said rail into said notch and engaging said bracket in said notch for vertically supporting said rail with said bracket.

2. The sliding door as set forth in claim 1 wherein said boss presents a contact surface and said bracket presents an adjoining surface partially defining said notch and in contact with said contact surface of said boss wherein said contact surface of said boss and said adjoining surface of said bracket establishes a fastener-free support to support the weight of said panel and said rail.

3. The sliding door as set forth in claim 2 wherein said boss defines a hole and said bracket defines an orifice extending into said bracket at said notch with said orifice in alignment with said hole.

4. The sliding door as set forth in claim 3 further including a fastener extending through said hole and into said orifice for maintaining the engagement of said boss and said bracket at said notch.

5. The sliding door as set forth in claim 4 wherein said bracket defines threads in said orifice and said fastener is threaded and threadedly engages said threads in said orifice for maintaining the engagement of said boss and said bracket at said notch.

6. The sliding door as set forth in claim 3 wherein said boss is further defined as having a frustoconical shape.

7. The sliding door as set forth in claim 6 wherein said notch is trapezoidal-shaped and is defined by a base surface extending between a first end and a second end with said adjoining surface extending downwardly from said first end at an obtuse angle relative to said base surface and with an opposite surface extending upwardly from said second end at an obtuse angle relative to said base surface for receiving said frustoconical shape of said boss in said notch.

8. The sliding door as set forth in claim 7 wherein said orifice is defined through said base surface of said bracket and said hole is defined through said frustoconical shape of said boss concentrically with said frustoconical shape of said boss.

9. The sliding door as set forth in claim 1 wherein said rail is further defined by a side partially adjacent said boss with said boss extending in a first direction from said side and a first member extending from said side generally in said first direction and a second member extending from said side generally in parallel with said first member in said first direction and spaced from said first member for defining a U-shaped cross-section with said boss extending into the U-shaped cross-section.

10. The sliding door as set forth in claim 9 wherein said rail receives and is secured to said panel between said first member and said second member with said bracket disposed between said panel and said side of said rail.

11. The sliding door as set forth in claim 10 wherein adhesive is disposed in said rail between said side and said first member and said second member and is adhered to said rail and said panel for securing said panel in the U-shaped cross-section.

12. The sliding door as set forth in claim 1 wherein said at least one support apparatus is further defined as a first support apparatus and a second support apparatus and said panel extends between said first support apparatus and said second support apparatus.

13. The sliding door as set forth in claim 1 wherein said bracket includes an extension and a roller rotatably mounted to said extension for rotating along the overhead track to moveably interact with said overhead track.

14. The sliding door as set forth in claim 13 wherein said extension defines a vertically oblong slot and said roller includes a fastening device to fasten said roller to said extension along said oblong slot such that a position of said roller relative to said extension is adjustable along said oblong slot.

15. A sliding door assembly for enclosing a space, said sliding door assembly comprising:
an overhead track;
at least one sliding door moveably interacting with said overhead track and including a panel and at least one support apparatus for supporting said panel, said support apparatus comprising;
a rail extending generally vertically and connected to said panel;
a bracket defining a notch and extending upwardly from and partially adjacent to said rail and moveably interacting with said overhead track; and
a boss extending from said rail into said notch and engaging said bracket in said notch for vertically supporting said rail on said bracket.

16. The sliding door assembly as set forth in claim 15 wherein said boss presents a contact surface and said bracket presents an adjoining surface partially defining said notch and in contact with said contact surface of said boss wherein said contact surface of said boss and said adjoining surface of said bracket establish a fastener-free support to support the weight of said panel and said rail.

17. The sliding door assembly as set forth in claim 16 wherein said boss defines a hole and said bracket defines an orifice extending into said bracket at said notch with said orifice in alignment with said hole.

18. The sliding door assembly as set forth in claim 17 further including a fastener extending through said hole and into said orifice for maintaining the engagement of said boss and said bracket at said notch.

19. The sliding door assembly as set forth in claim 18 wherein said bracket defines threads in said orifice and said fastener is threaded and threadedly engages said threads in said orifice for maintaining the engagement of said boss and said bracket at said notch.

20. The sliding door assembly as set forth in claim 17 wherein said boss is further defined as having a frustoconical shape.

21. The sliding door as set forth in claim 20 wherein said notch is trapezoidal-shaped and is defined by a base surface extending between a first end and a second end with said adjoining surface extending downwardly from said first end at an obtuse angle relative to said base surface and with an opposite surface extending upwardly from said second end at an obtuse angle relative to said base surface for receiving said frustoconical shape of said boss in said notch.

22. The sliding door assembly as set forth in claim 21 wherein said orifice is defined through said base surface of said bracket and said hole is defined through said frustoconical shape of said boss concentrically with said frustoconical shape of said boss.

23. The sliding door assembly as set forth in claim 16 wherein said overhead track presents a first ledge extending along said track and said at least one sliding door includes a first sliding door moveably interacting with said first ledge.

24. The sliding door assembly as set forth in claim 23 wherein said overhead track presents a second ledge spaced from and extending in parallel with said first ledge and said at least one sliding door includes a second sliding door moveably interacting with said second ledge such that said first sliding door and said second sliding door are in a bi-pass arrangement.

25. A support apparatus for supporting a panel, said support apparatus comprising;
a rail extending generally vertically for connection to the panel;
a bracket defining a notch and extending upwardly from and partially adjacent to said rail for moveable interaction with an overhead track; and
a boss extending from said rail into said notch and engaging said bracket in said notch for vertically supporting said rail with said bracket.

26. The support apparatus as set forth in claim 25 wherein said boss presents a contact surface and said bracket presents an adjoining surface partially defining said notch and in contact with said contact surface of said boss wherein said contact surface of said boss and said adjoining surface of said bracket establishes a fastener-free support to support the weight of said rail and the panel.

27. The support apparatus as set forth in claim 26 wherein said boss defines a hole and said bracket defines an orifice extending into said bracket at said notch with said orifice in alignment with said hole.

28. The support apparatus as set forth in claim 27 further including a fastener extending through said hole and into said orifice for maintaining the engagement of said boss and said bracket at said notch.

29. The support apparatus as set forth in claim 28 wherein said bracket defines threads in said orifice and said fastener is threaded and threadedly engages said threads in said orifice for maintaining the engagement of said boss and said bracket at said notch.

30. The support apparatus as set forth in claim 27 wherein said boss is further defined as having a frustoconical shape.

31. The support apparatus as set forth in claim 29 wherein said notch is trapezoidal-shaped and is defined by a base surface extending between a first end and a second end with said adjoining surface extending downwardly from said first end at an obtuse angle relative to said base surface and with an opposite surface extending upwardly from said second end at an obtuse angle relative to said base surface for receiving said frustoconical shape of said boss in said notch.

32. The support apparatus as set forth in claim 30 wherein said orifice is defined through said base surface of said bracket and said hole is defined through said frustoconical shape of said boss concentrically with said frustoconical shape of said boss.
